(19) United States
(12) Patent Application Publication
(10) Pub. No.: US 2008/0222674 A1
(43) Pub. Date: Sep. 11, 2008

(54) Method, System And Apparatus For Implementing Pay Per View Multicast Service

(75) Inventor: Deyi Wang, Shenzhen (CN)

Correspondence Address: HARNESS, DICKEY & PIERCE, P.L.C., P.O. BOX 828, BLOOMFIELD HILLS, MI, 48303, US

(73) Assignee: Huawei Technologies Co., Ltd.

(21) Appl. No.: 12/102,418

(22) Filed: Apr. 14, 2008

Related U.S. Application Data
(63) Continuation of application No. PCT/CN2006/003040, filed on Nov. 13, 2006.

(30) Foreign Application Priority Data
Feb. 28, 2006 (CA) 200610034082.7

(51) Int. Cl. H04N 7/16

(52) U.S. Cl. 725/29

(57) ABSTRACT

Various embodiments of the present disclosure provide a method for implementing a Pay Per View (PPV) multicast service, including: sending, by a user terminal, a PPV program playing request to an access device; determining, by the access device, whether the user terminal has the right to receive the PPV program based on the current time and the acquired right information of the user terminal; if the user terminal has the right, forwarding the PPV program data stream from a multicast source to the user terminal. In accordance with the present disclosure, an access device may control the time of forwarding a program data stream to a user terminal according to the right of the user terminal of receiving the program, thus a PPV multicast service is implemented.

### CROSS-REFERENCE TO RELATED APPLICATIONS

This application is a continuation of International Application No. PCT/CN2006/003040, filed Nov. 13, 2006. This application claims the benefit of Chinese Application No. 200610034082.7, filed Feb. 28, 2006. The disclosures of the above applications are incorporated herein by reference.

### FIELD

The present disclosure relates to multicast technologies, and particularly, to a method for implementing a Pay Per View (PPV) multicast service.

### BACKGROUND

The statements in this section merely provide background information related to the present disclosure and may not constitute prior art.

At present, network TV services are usually provided by multicasting technology. FIG. 1 is a schematic diagram illustrating an elementary architecture of a multicast network. Referring to FIG. 1, the multicast network includes a user terminal, an access device, an authentication device and a multicast source. When a user terminal intends to join a multicast group, the user terminal first sends a multicast group joining request to an access device. On receipt of the request, the access device determines whether to forward a multicast data stream to the user terminal based on the right information of the user terminal saved in the access device or acquired from an authentication device. If the user terminal does not have the right, the access device rejects the request of the user terminal. If the user terminal has the right, the access device sends a request success response message to the user terminal, adds the address information of the user terminal to the multicast forwarding table corresponding to the multicast group, and forwards the multicast data stream from the multicast source to the user terminal. Thereafter, the access device checks at intervals whether the user terminal is still receiving the multicast data stream; if the user terminal needs to be kept staying in the multicast group, it must return a response to the access device. On receipt of the response, the access device keeps on forwarding the multicast data stream to the user terminal; otherwise, the access device stops forwarding the multicast data stream. Such a process may also exist between a multicast source and an access device to maintain the forwarding of the multicast data stream. A user terminal may interact with an access device by using Internet Group Management Protocol (IGMP) packets, and an access device may interact with a multicast source by using IGMP packets, either.

At present, the multicast network only provides users with conventional multicast programs, in which a user terminal, after being authorized, may join a multicast group and receive the multicast program or leave the multicast group and stop receiving the multicast program at any time. In practice, an operator may need to provide user terminals with Pay Per View (PPV) programs. The PPV programs are programs to which a time period is set and which can only be received by user terminals within the specified time period. Within the scope of the prior art, no solution is proposed to grant a user terminal the right to receive a PPV program and to cancel the right to receive the PPV program for the user terminal based on time, thus a multicast service for a PPV program can hardly be implemented.

### SUMMARY

The present disclosure provides a method for implementing a Pay Per View (PPV) multicast service. The method may authorize a user terminal at the beginning of a program, and cancel the right of the user terminal at the ending of the program.

According to various embodiments, a method for implementing a Pay Per View (PPV) multicast service, includes:
S1. sending, by a user terminal, a PPV program playing request to an access device;
S2. determining, by the access device, whether the user terminal has the right to receive a PPV program based on the current time and the acquired right information of user terminal; if the user terminal has the right, forwarding the PPV program data stream from a multicast source to the user terminal.

In the above scheme, the right information in Step S2 includes: an effective time indicating the time when the right of the user terminal to receive the PPV program comes into effect, and an expiration time indicating the time when the right of the user terminal to receive the PPV program expires;
in Step S2, determining whether the user terminal has the right to receive the PPV program includes:
comparing, by the access device, the current time with the effective time and the expiration time; if the current time exceeds the effective time and has not reached the expiration time, determining that the user terminal has the right to receive the program; otherwise, the user terminal does not have the right to receive the program.

In the above scheme, before the step S1, the method further includes:
after receiving a program booking request, determining, by the authentication device, the effective time and the expiration time according to the program booking request, and sending the generated right information including the effective time and the expiration time to the access device; saving, by the access device, the right information including the effective time and the expiration time.

In the above scheme, the program booking request contains a program identity;
determining the effective time and the expiration time by the authentication device includes:
acquiring, by the authentication device, a start time and an end time of a program corresponding to the program identity from the program information saved in the authentication device according to the received program identity; designating the start time as the effective time and the end time as the expiration time.

In the above scheme, the program booking request contains a start time and an end time;
determining the effective time and the expiration time by the authentication device includes:
designating the start time contained in the program booking request as the effective time and the end time contained in the program booking request as the expiration time.

In the above scheme, the method for saving the effective time and the expiration time includes:
saving, by the access device, the effective time and the expiration time as the parameters of the program attributes; or, saving the effective time and the expiration time as the parameters of the template attributes.

In the above scheme, after the step S2, the method further includes:
determining, by the access device, in real time whether the current time exceeds or reaches the expiration time; if the current time exceeds or reaches the expiration time, stopping forwarding the PPV program data stream to the user terminal; or,
determining, by the authentication device, in real time whether the current time exceeds or reaches the expiration time; if the current time exceeds or reaches the expiration time, notifying the access device that the right of the user terminal has terminated; stopping forwarding, by the access device, the PPV program data stream to the user terminal.

In the above scheme, after the authentication device sends the right information to the access device, the method further includes:
determining, by the authentication device, in real time whether the current time exceeds or reaches the expiration time; if the current time exceeds or reaches the expiration time, notifying the access device that the right of the user terminal has terminated.

After the Step S2, the method further includes: after receiving the notification about the terminating of the right of the user terminal from the authentication device, stopping forwarding, by the access device, the PPV program data stream to the user terminal.

As described above, because the access device may forward a program data stream and stop forwarding the program data stream to the user terminal based on time parameters in the right information of the user terminal, thus a multicast service is implemented in which the right of a user terminal to receive a program is determined based on time.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram illustrating the elementary architecture of a multicast network.

FIG. 2 is a flowchart in accordance with the present disclosure.

FIG. 3 is a flowchart illustrating an embodiment in accordance with the present disclosure.

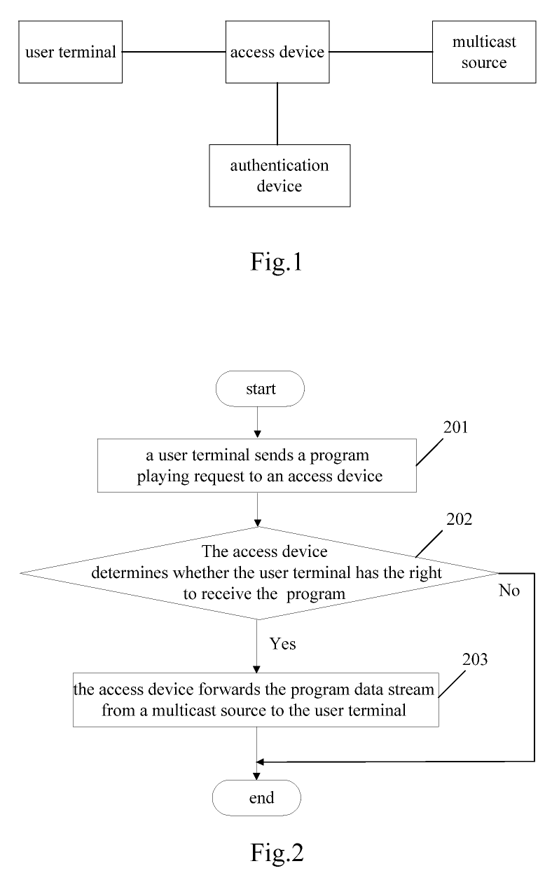

### DETAILED DESCRIPTION

The following description is merely exemplary in nature and is not intended to limit the present disclosure, application, or uses.

A detailed description of the present disclosure is provided hereinafter with reference to the attached drawings and specific embodiments.

FIG. 2 is a flowchart in accordance with an embodiment of the present disclosure. As shown in FIG. 2, a method provided by various embodiments of the present disclosure for implementing a Pay Per View (PPV) multicast service includes the following steps.

Step 201: a user terminal sends a PPV program playing request to an access device.

Steps 202˜203: the access device determines whether the user terminal has the right to receive a PPV program according to the current time and the acquired right information of the user terminal, and forwards a PPV program data stream from a multicast source to the user terminal if the user terminal has the right.

According to an embodiment of the present disclosure, the right information of a user terminal includes an effective time indicating the time when the right of a user terminal to receive a PPV program goes into effect and an expiration time indicating the time when the right of a user terminal to receive a PPV program expires.

When determining whether a user terminal has the right to receive a PPV program, the access device may compare the current time with the effective time and the expiration time. If the current time exceeds or reaches the effective time and has not reached the expiration time, the access device determines that the user terminal has the right to receive the program. Otherwise, the access device determines that the user terminal does not have the right to receive the program. In this way, the access device can control the forwarding of the PPV program data stream to the user terminal.

Before a user terminal receives a PPV program multicast service, the access device needs to obtain the right information of the user terminal. The method includes the following steps: a terminal device sends a program booking request to an authentication device; the authentication device determines an effective time and an expiration time for the right information of the user, and sends the generated right information including the effective time and the expiration time to an access device; and the access device obtains and stores the right information including the effective time and the expiration time. It can be understood that the terminal device may be a user terminal described in the present disclosure or one of other terminal devices, for example an ordinary PC, as long as it has the ability to browse the web site of the authentication device, to book a program at the authentication device and to request the authentication device to authorize the user terminal the right to receive the booked program.

According to an embodiment of the present disclosure, the method for generating the right information of a user terminal by the authentication device is similar to that in the prior art, and the difference lies in that, the authentication device needs to further determine the effective time and the expiration time for the right information.

There are pluralities of methods for the authentication device to determine the effective time and the expiration time. For example, program information may be saved in the authentication device in advance, and the program information includes the identity as well as the start time and the end time of the program. A terminal device sends a program booking request carrying the identity of the program to the authentication device, then the authentication device may take the start time of the program corresponding to the program identity as the effective time and take the end time of the program as the expiration time.

For yet another example, the terminal device directly specifies the start time and the end time in the program booking request, and the authentication device may take the start time and the end time designated by the user as the effective time and the expiration time respectively. The start time and the end time in the present method, which may be determined by the user, are different from the start time and the end time of the program in the foregoing method. It can be understood that the authentication device may also determine the effective time and the expiration time using other methods, which will not be listed one by one any more herein.

To make the present disclosure more apparent, various embodiments of the method for implementing a PPV multicast service are described hereinafter.

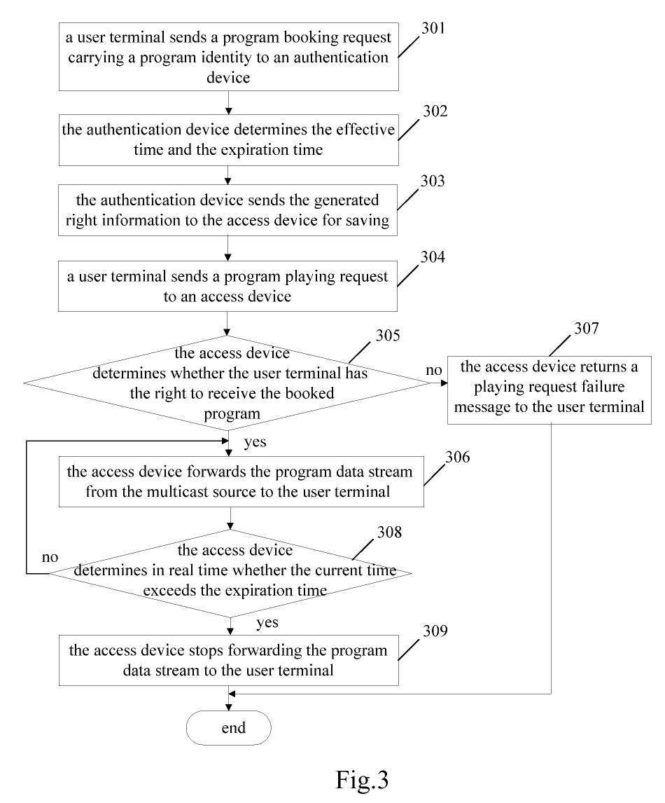

FIG. 3 is a flowchart of the embodiment in accordance with the present disclosure. As shown in FIG. 3, the method provided by the embodiment for implementing multicast service includes the following steps.

Step 301: a user terminal sends a program booking request containing a program identity to an authentication device.

The user terminal typically needs to send the program booking request to the authentication device via an IP network.

Step 302: the authentication device acquires a start time and an end time of the program corresponding to the program identity from the stored program information according to the program identity, determines the start time as an effective time and the end time as an expiration time.

Step 303: the authentication device sends the generated right information including the effective time and the expiration time to the access device; the access device saves the effective time and the expiration time as parameters of corresponding program attributes.

The access device may bind the user terminal with the program and the right information of the program to implement forwarding of the data stream of the program to the user terminal. In this case, a program attribute table, which is used for describing and controlling the forwarding of the programs, may be set in the access device. And the effective time and the expiration time may be saved in the program attribute table as parameters of the program attributes.

The access device may also bind the user terminal with a template corresponding to multiple programs and with the right information of the template, and thus implement the forwarding of the data stream of the program to the user terminal. In this case, a template attribute table may be stored in the access device, which is used for describing and controlling the forwarding of the program and in which the effective time and the expiration time may be saved as parameters of the template attributes.

It should be understood that the effective time and the expiration time may also be saved directly as individual variables instead of being saved as parameters of the program attributes or of the template attributes.

After generating the right information, the authentication device may send the right information to the access device immediately or when the time reaches the effective time.

The values of the right information may specify the right of watching, previewing or no right. The method for generating the right information and the above mentioned types of the right information are in accordance with the prior art, which will not be further described herein.

Step 304: a user terminal sends a PPV program playing request to an access device.

Steps 305˜307: the access device compares the current time with the effective time and the expiration time, and determines whether the user terminal has the right to receive the booked PPV program according to the compare result; if the user terminal has the right, the access device forwards the PPV program data stream from the multicast source to the user terminal, and proceeds to Step 308; if the user terminal does not have the right, the access device returns a playing request failure message to the user terminal, and quits this procedure.

In this embodiment, upon determining that the user terminal does not have the right of receiving the program, the access device returns a playing request failure message to the user terminal. In practice, the access device may also not return a playing request failure message, i.e. perform nothing.

Steps 308˜309: the access device determines in real time whether the current time exceeds or reaches the expiration time. If the current time exceeds or reaches the expiration time, the access device stops forwarding the PPV program data stream to the user terminal; otherwise, the access device keeps on forwarding the PPV program data stream from the multicast source to the user terminal.

In this embodiment, the access device initiates an expiration detection by itself at the beginning of forwarding the program data stream to the user terminal, i.e. checks in real time whether the current time exceeds or reaches the expiration time.

In practice, the authentication device may also be used for determining in real time whether the current time exceeds or reaches the expiration time, which includes: after sending the right information of the user terminal to the access device, the authentication device initiates an expiration detection, and determines in real time whether the current time exceeds or reaches the expiration time; if the current time exceeds or reaches the expiration time, the authentication device notifies the access device that the right of the user terminal has terminated, and the access device stops forwarding the PPV program data stream to the user terminal; or,

upon starting forwarding the data stream of the program to the user terminal, the access device notifies the authentication device that the user terminal starts receiving the data stream of the program; the authentication device initiates an expiration detection, and determines in real time whether the current time exceeds or reaches the expiration time; if the current time exceeds or reaches the expiration time, the authentication device notifies the access device that the right of the user terminal has terminated; then the access device stops forwarding the PPV program data stream to the user terminal.

The multicast source may provide one or more channels to the user terminal, and the channels are conventional multicast programs and each of such channels includes several programs. If only one channel is provided, the interactive messages among the user terminal, the access device and the authentication device need not include a channel identity for identifying different channels; if more than one channels are provided, the interactive messages among the user terminal, the access device and the authentication device will need to include the channel identity.

In addition, the effective time and the expiration time may be an absolute time such as 12:30:31, Dec. 31, 2005 or a relative time such as the number of 50-milliseconds from 12:30:31, Dec. 31, 2005.

With the solution of the present disclosure, an access device may forward the PPV program data stream booked by a user terminal to the user terminal when the current time reaches the effective time, and stops forwarding the PPV program data stream to the user terminal when the current time reaches the expiration time, and thus a PPV multicast service can be implemented effectively.

What is claimed is:

1. A method for implementing a Pay Per View (PPV) multicast service, comprising:
receiving, by an access device, right information of one or more user terminals sent from an authentication device, wherein the right information comprises time parameters for determining a time limitation of the right of the user terminal;
determining, by the access device, on receiving a PPV program playing request from a user terminal, whether the user terminal has the right of receiving the PPV program based on the time parameters in the right information of the user terminal, and forwarding the program data stream from a multicast source to the user terminal when it is determined that the user terminal has the right.

2. The method according to claim 1, wherein the time parameters in the right information comprise a time period parameter indicating a time period during which the right of the user is effective; and
determining by the access device whether the user terminal has the right of receiving the PPV program comprises:
determining whether the current time falls into the time period indicated by the time period parameter, if the current time falls into the time period, the user terminal has the right to receive the program; otherwise, the user terminal does not have the right to receive the program.

3. The method according to claim 1, wherein the time parameters comprise effective time indicating the time when the right of the user terminal to receive the program comes into effect, and expiration time indicating the time when the right of the user terminal to receive the program expires; and
determining by the access device whether the user terminal has the right of receiving the PPV program comprises:
comparing, by the access device, the current time with the effective time and the expiration time; if the current time falls between the effective time and the expiration time, the user terminal has the right to receive the program; otherwise, the user terminal does not have the right to receive the program.

4. The method according to claim 1, further comprising:
receiving, by the authentication device, a PPV program booking request from the user terminal, wherein the PPV program booking request comprises time information for determining time limitation of the right of the user terminal;
determining, by the authentication device, time parameters based on the time information;
generating, by the authentication device, right information containing the determined time parameters;
sending, by the authentication device, the generated right information to the access device.

5. The method according to claim 4, wherein
the time information contained in the PPV program booking request comprises a start time and an end time designated by the user terminal;
the time parameters comprise effective time indicating the time when the right of the user terminal to receive the PPV program comes into effect, and expiration time indicating the time when the right of the user terminal to receive the PPV program expires; and
determining by the authentication device time parameters comprises:
determining, by the authentication device, the start time as the effective time and the end time as the expiration time

6. The method according to claim 4, wherein
the time information contained in the PPV program booking request comprises a PPV program identity;
the time parameters comprise effective time indicating the time when the right of the user terminal to receive the PPV program comes into effect, and expiration time indicating the time when the right of the user terminal to receive the PPV program expires; and
determining by the authentication device time parameters based on the time information comprises:
acquiring, by the authentication device, PPV program information saved in the authentication device according to the PPV program identity, wherein the PPV program information comprises the start time and end time of the PPV program;
determining, by the authentication device, the start time of the PPV program as the effective time and the end time of the PPV program as the expiration time.

7. The method according to claim 1, further comprising:
saving, by the access device, the right information as the parameters of the PPV program attributes or as the parameters of the template attributes; and
acquiring, by the access device, the right information from the parameters of the PPV program attributes or from the parameters of the template attributes, and obtaining the time parameters from the right information.

8. The method according to claim 1, further comprising:
determining, by the access device, in real time whether the right of user terminal is expired based on the time parameters, stopping forwarding the PPV program data stream to the user terminal when the right is expired.

9. The method according to claim 1, further comprising:
determining, by the authentication device, in real time whether the right of user terminal has expired based on the time parameters, notifying the access device that the right of the user terminal has terminated when it is determined that the right has expired;
stopping forwarding, by the access device on receiving the notification about the termination of the right of the user terminal from the authentication device, the PPV program data stream to the user terminal.

10. A system for implementing a Pay Per View (PPV) multicast service, comprising:
an access device, communicating with a user terminal and an authentication device, adapted to receive right information sent by the authentication device and a PPV program playing request from the user terminal, wherein the right information comprises time parameters, determine whether the user terminal has the right of receiving the PPV program based on the time parameters and forwarding the PPV program data stream from a multicast source to the user terminal if the user terminal has the right.

11. The system according to claim 10, further comprising:
the user terminal adapted to send a PPV program booking request to an authentication device, wherein the PPV program booking request comprises time information for determining a time limitation of the right of the user terminal; and
the authentication device, adapted to receive a PPV program booking request sent from the user terminal, determine time parameters based on the time information comprised in the PPV program booking request, generate right information containing the determined time parameters, and send the generated right information to the access device.

12. An access device for implementing a Pay Per View (PPV) multicast service, comprising:
a first interface, adapted to receive a PPV program playing request from a user terminal, send a PPV program data stream to the user terminal;
a second interface, adapted to receive the right information of the user terminal sent by an authentication device, wherein the right information comprises time parameters for determining a time limitation of the right of the user terminal;
a right determining unit, adapted to determine whether the user terminal has the right of receiving the PPV program based on the time parameters, and forward the PPV program data stream from a multicast source to the user terminal if the user terminal has the right.

13. The access device according to claim 12, wherein,
the right determining unit is adapted further to determine whether the current time falls into the time period indicated by the time parameters, the user terminal has the right to receive the PPV program if the current time falls into the time period; otherwise, the user terminal does not have the right to receive the PPV program.

14. An authentication device for implementing a Pay Per View (PPV) multicast service, comprising:
an interface, adapted to receive a PPV program booking request which contains time information for determining a time limitation of the right of the user terminal, and send right information of one or more user terminals to an access device;
a right generating unit, adapted to determine time parameters based on the time information for determining a time limitation of the right of the user terminal, generate right information of the user terminal containing the time parameters.

15. The authentication device according to claim 14, further comprising:
a storage unit, adapted to store information of PPV programs;
the right generating unit is further adapted to determine effective time indicating the time when the right of the user terminal to receive the PPV program comes into effect, and expiration time indicating the time when the right of the user terminal to receive the PPV program expires based on the time information.

16. The authentication device according to claim 14, further comprising:
an expiration detecting unit, adapted to determine in real time whether the right of user terminal has expired based on the time parameters, and notify the access device that the right of the user terminal has terminated when it is determined that the right has expired.
